(19) United States
(12) Patent Application Publication
(10) Pub. No.: US 2015/0187452 A1
(43) Pub. Date: Jul. 2, 2015

(54) COPPER ALLOY WIRE AND COPPER ALLOY WIRE MANUFACTURING METHOD

(71) Applicants: Hitoshi Nakamoto, Osaka (JP); Norikazu Ishida, Tokyo (JP); Kazunari Maki, Kitamoto-shi (JP); Hiroyuki Mori, Kitamoto-shi (JP); Tetsuya Ashida, Amagasaki-shi (JP)

(72) Inventors: Hitoshi Nakamoto, Osaka (JP); Norikazu Ishida, Tokyo (JP); Kazunari Maki, Kitamoto-shi (JP); Hiroyuki Mori, Kitamoto-shi (JP); Tetsuya Ashida, Amagasaki-shi (JP)

(73) Assignees: MITSUBISHI CABLE INDUSTRIES, LTD., Tokyo (JP); MITSUBISHI MATERIALS CORPORATION, Tokyo (JP)

(21) Appl. No.: 14/413,107

(22) PCT Filed: Jul. 31, 2012
(86) PCT No.: PCT/JP2012/069479

§ 371 Date: Jan. 6, 2015

(51) Int. Cl. H01B 1/02; C22C 9/06; C22F 1/08

(52) U.S. Cl. CPC H01B 1/026; C22F 1/08; C22C 9/06

(57) ABSTRACT

This copper alloy wire consists of a precipitation strengthening type copper alloy containing Co, P, and Sn, wherein an average grain size of precipitates observed through cross-sectional structure observation immediately after performing an intermediate aging heat treatment is equal to or less than 15 nm and a number of precipitates having grain sizes of equal to or less than 5 nm is 10% or higher of a total number of observed precipitates, and the copper alloy wire is subjected to cold working and a final aging heat treatment after the intermediate aging heat treatment.

### CROSS-REFERENCE TO RELATED PATENT APPLICATIONS

This application is a U.S. National Phase Application under 35 U.S.C. §371 of International Patent Application No. PCT/JP2012/069479, filed Jul. 31, 2012, which is incorporated by reference in its entirety herein. The International Application was published in Japanese on Feb. 6, 2014 as International Publication No. WO/2014/020701 under PCT Article 21(2).

### FIELD OF THE INVENTION

The present invention relates to a copper alloy wire used in, for example, wiring of a vehicle or a device, and a method for manufacturing a copper alloy wire.

### BACKGROUND OF THE INVENTION

Hitherto, for example, as described in Patent Documents 1 and 2, as an electric wire for wiring of a vehicle and wiring of a device, an electric wire conductor which is made by stranding a plurality of copper wires together and is covered with an insulation covering is provided. In addition, in order to efficiently form the wiring and the like, a wire harness made by binding a plurality of the electric wires together is provided.

In recent years, from the viewpoint of environmental protection, in order to reduce the amount of carbon dioxide emitted from vehicles, a reduction in the weight of the vehicle body has been strongly demanded. On the other hand, due to the progress of automotive electronics and the progress of the development of hybrid vehicles and electric vehicles, the number of components of an electrical system used in a vehicle has increased at an accelerated rate. Accordingly, a further increase in the amount of wire harnesses used to connect such components is expected and a reduction in the weight of the wire harness is required.

Here, as a method for reducing the weight of the wire harness, a reduction in the diameters of the electric wire and the copper wire is achieved. In addition, due to the reduction in the diameters of the electric wire conductor and the copper wire, a reduction in the size of the wire harness is also achieved as well as a weight reduction, and thus there is an advantage in that a wiring space may be effectively used.

Hitherto, as the above-described copper wire, a wire made of tough pitch copper is mainly used, and for the purpose of absorbing impacts due to vibration during the assembly of the wire harness or after the attachment thereof to a vehicle, an annealed copper wire which is subjected to a heat treatment at a high temperature is used. The annealed copper wire is soft, and has high elongation, and thus impacts from the outside can be absorbed. On the other hand, the annealed copper wire is extremely vulnerable to an instantaneously applied tensile load and easily reaches a plastic deformation region over an elastic deformation region. As a result, when a heavier load is applied, the annealed copper wire is broken. That is, the copper wire made of the tough pitch copper has sufficient elongation but has insufficient strength.

Regarding the copper wire made of the tough pitch copper, strength cannot be sufficiently secured, and a reduction in weight and size caused by a reduction in diameter could not be achieved.

Accordingly, as a copper wire having enhanced strength, for example, as described in Patent Documents 3 and 4, a copper alloy wire made of Sn-containing copper which contains 0.2 mass % to 2.5 mass % of Sn is provided.

The Sn-containing copper is a solid solution strengthening type copper alloy in which the strength thereof is enhanced by solutionizing Sn in the matrix of copper and thus has sufficiently enhanced strength compared to the above-mentioned tough pitch copper.

### PRIOR ART DOCUMENTS

### Patent Documents

Patent Document 1: Japanese Unexamined Patent Application, First Publication No. 2008-016284

Patent Document 2: Japanese Unexamined Patent Application, First Publication No. H06-150732

Patent Document 3: Japanese Unexamined Patent Application, First Publication No. 2008-027640

Patent Document 4: Japanese Patent (Granted) Publication No. 2709178

### Problems to be Solved by the Invention

However, in the solid solution strengthening type copper alloy such as the Sn-containing copper and the like, elongation is insufficient although strength is high in a state of being formed by cold working, and wire flipping or wire entanglement easily occurs during the assembly of the wire harness and handleability is poor. As a method of improving the elongation of the Sn-containing copper, recovering the structure through a heat treatment is considered. However, when the heat treatment temperature of the Sn-containing copper reaches the softening point, tensile strength and elongation are rapidly changed, and thus it is difficult to control tensile strength and elongation by adjusting heat treatment conditions.

Therefore, even in the case where the Sn-containing copper is used, it is not possible to satisfy both of elongation and strength and a reduction in the diameter of the copper wire cannot be achieved.

The present invention has been made while taking the foregoing circumstances into consideration, and an object thereof is to provide a copper alloy wire which is excellent in strength and elongation and can achieve a reduction in the diameter of a wire harness, and a method for manufacturing a copper alloy wire.

### SUMMARY OF THE INVENTION

### Means for Solving the Problems

In order to solve the above-described problems, a copper alloy wire according to the invention consists of a precipitation strengthening type copper alloy containing Co, P, and Sn, wherein an average grain size of precipitates observed through cross-sectional structure observation immediately after performing an intermediate aging heat treatment is equal to or less than 15 nm and a number of precipitates having grain sizes of equal to or less than 5 nm is 10% or higher of a total number of observed precipitates, and the copper alloy wire is subjected to cold working and a final aging heat treatment after the intermediate aging heat treatment.

The copper alloy wire according to the present invention described above consists of a precipitation strengthening type copper alloy containing Co, P, and Sn, the average grain size of precipitates observed through cross-sectional structure observation immediately after performing the intermediate aging heat treatment is equal to or less than 15 nm, and the number of precipitates having grain sizes of equal to or less than 5 nm is 10% or higher of the total number of observed precipitates; and therefore, a large amount of the precipitates consisting of compounds containing Co and P and having small grain sizes are dispersed in the matrix phase of copper. Here, when cold working is performed after the intermediate aging heat treatment, dislocations are generated, and dislocation loops are formed in parts of the precipitates having small grain sizes. In addition, the precipitates having small grain sizes are sheared and divided by the dislocations and thus the precipitates are re-solutionized in the matrix phase of copper.

Then, when this copper alloy wire is subjected to a final aging heat treatment, the precipitates consisting of compounds containing Co and P which are re-solutionized are re-precipitated on the dislocation loops as the precipitation sites. As a result, electrical conductivity is enhanced and strength is also enhanced by precipitation strengthening. In addition, due to this heat treatment, the dislocations are released and thus elongation is recovered. Therefore, the copper alloy wire which is excellent in strength and elongation can be obtained.

In addition, the final aging heat treatment after the cold working may be performed on a copper alloy wire or may also be performed after stranding a plurality of copper alloy wires together.

Here, it is preferable that a composition of the precipitation strengthening type copper alloy include: 0.12 mass % or higher to 0.40 mass % or less of Co; 0.040 mass % or higher to 0.16 mass % or less of P; and 0.005 mass % or higher to 0.70 mass % or less of Sn, with the remainder being Cu and unavoidable impurities.

In the copper alloy wire having the above-described composition, the precipitates consisting of compounds containing Co and P are dispersed in the matrix phase of copper; and thereby, it is possible to achieve the enhancement of strength and electrical conductivity.

In addition, in the case where the Co content and the P content are lower than the lower limit, the number of precipitates is insufficient, and thus strength cannot be sufficiently enhanced. On the contrary, in the case where the Co content and the P content are higher than the upper limit, a large number of elements that do not contribute to the enhancement of strength are present, and there is concern that a reduction in electrical conductivity and the like may be caused. Therefore, it is preferable that the Co content and the P content be set to be in the above-described ranges.

In addition, Sn is an element having an action of being solutionized in the matrix phase of copper and thus enhancing strength. In addition, Sn also has an effect of accelerating the precipitation of precipitates primarily containing Co and P, and Sn can enhance heat resistance and corrosion resistance. In order to reliably achieve these effects, the Sn content needs to be equal to or higher than 0.005 mass %. In addition, in the case where an excessive amount of Sn is added, a reduction in electrical conductivity is caused. Therefore, it is preferable that the Sn content be equal to or less than 0.70 mass %.

In addition, it is preferable that the precipitation strengthening type copper alloy further include: 0.01 mass % or higher to 0.15 mass % or less of Ni.

The copper alloy wire having the above-described composition contains Ni at a content in the above-described range and thus the coarsening of grains can be suppressed; and thereby, strength can be further enhanced.

In addition, it is preferable that the precipitation strengthening type copper alloy further include one or more selected from 0.002 mass % or higher to 0.5 mass % or less of Zn, 0.002 mass % or higher to 0.25 mass % or less of Mg, 0.002 mass % or higher to 0.25 mass % or less of Ag, and 0.001 mass % or higher to 0.1 mass % or less of Zr.

The copper alloy wire having the above-described composition contains one or more of Zn, Mg, Ag, and Zr at contents in the above-described ranges. Accordingly, such elements form compounds with sulfur (S); and thereby, it is possible to suppress the sulfur (S) from being solutionized in the matrix phase of copper. As a result, it is possible to suppress the deterioration of mechanical properties such as strength and the like.

In addition, it is preferable that the copper alloy wire of the present invention have a tensile strength of 450 MPa or higher and an elongation of 5% or higher.

In the copper alloy wire having the above-described feature, tensile strength and elongation are secured; and therefore, it is possible to achieve a reduction in the thickness of a wire harness.

A copper alloy wire manufacturing method of the present invention is a method for manufacturing a copper alloy wire consisting of a precipitation strengthening type copper alloy containing Co, P, and Sn, and the method includes: an intermediate aging heat treatment process; a cold working process performed after the intermediate aging heat treatment process; and a final aging heat treatment process performed after the cold working process, wherein an average grain size of precipitates observed through cross-sectional structure observation immediately after performing the intermediate aging heat treatment process is made to be equal to or less than 15 nm and a number of precipitates having grain sizes of equal to or less than 5 nm is made to be 10% or higher of a total number of observed precipitates.

The copper alloy wire manufacturing method according to the present invention described above includes: the intermediate aging heat treatment process; the cold working process performed after the aging heat treatment process; and the final aging heat treatment process performed after the cold working process, and the average grain size of precipitates observed through cross-sectional structure observation immediately after performing the intermediate aging heat treatment process is made to be equal to or less than 15 nm and the number of precipitates having grain sizes of equal to or less than 5 nm is made to be 10% or higher of the total number of observed precipitates; and therefore, the precipitates can be re-solutionized in the cold working process. As a result, by performing the final aging heat treatment on the copper alloy wire, the precipitates can be uniformly dispersed, and thus the copper alloy wire which is excellent in strength and elongation can be manufactured.

In addition, after the cold working process, a wire stranding working process of stranding a plurality of copper alloy wires together may be included.

In addition, the final aging heat treatment process after the cold working process may be performed on a single wire and may also be performed after the wire stranding working process.

### Effects of the Invention

According to the present invention, it is possible to provide a copper alloy wire which is excellent in strength and elongation and thus can achieve a reduction in the diameter of a wire harness, and a method for manufacturing a copper alloy wire.

### BRIEF DESCRIPTION OF THE DRAWINGS

FIG. 1 is a cross-sectional explanatory view of an insulation electric wire in which a copper alloy wire of an embodiment of the present invention is used.

FIG. 2 is a flowchart of a method for manufacturing the copper alloy wire of the embodiment of the present invention and a method for manufacturing an electric wire conductor.

FIG. 3 is a schematic explanatory view of a continuous casting and rolling facility used in the method for manufacturing the copper alloy wire of the embodiment of the present invention and the method for manufacturing an electric wire conductor.

FIG. 4 is a cross-sectional explanatory view of an insulation electric wire in which a copper alloy wire of another embodiment of the present invention is used.

### DETAILED DESCRIPTION OF THE INVENTION

### Embodiments for Carrying Out the Invention

Hereinafter, a copper alloy wire according to an embodiment of the present invention and a method for manufacturing a copper alloy wire will be described with reference to the accompanying drawings.

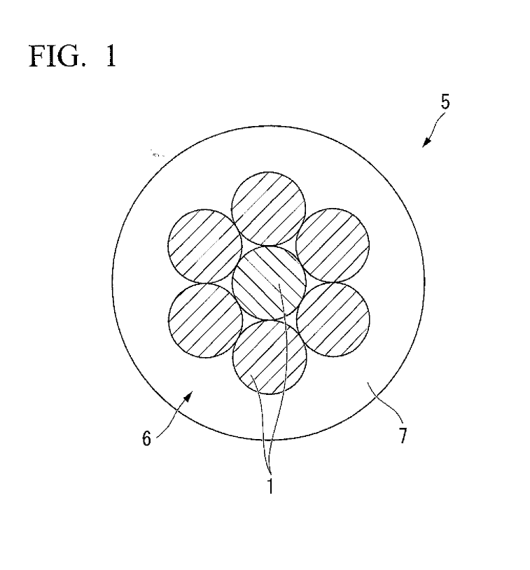

A copper alloy wire 1 of this embodiment is used as an element wire of an insulation electric wire 5 included in a wire harness. FIG. 1 illustrates an example of the insulation electric wire in which the copper alloy wire 1 of the embodiment of the present invention is used.

The insulation electric wire 5 includes: an electric wire conductor 6 made by stranding a plurality of copper alloy wires 1 (in FIG. 1, seven wires) together; and an insulation covering 7 which covers the outer circumference of the electric wire conductor 6.

It is preferable that the copper alloy wire 1 of this embodiment which is included in the above-mentioned electric wire conductor 6 consists of a copper alloy having a composition containing: 0.12 mass % or higher to 0.40 mass % or less of Co; 0.040 mass % or higher to 0.16 mass % or less of P; and 0.005 mass % or higher to 0.70 mass % or less of Sn, with the remainder being Cu and unavoidable impurities.

In addition, the copper alloy may further include 0.01 mass % or higher to 0.15 mass % or less of Ni. In addition, the copper alloy may further include one or more selected from 0.002 mass % or higher to 0.5 mass % or less of Zn, 0.002 mass % or higher to 0.25 mass % or less of Mg, 0.002 mass % or higher to 0.25 mass % or less of Ag, and 0.001 mass % or higher to 0.1 mass % or less of Zr.

Hereinafter, the reason that the content of each of the elements is set to be in the above-described range will be described.

### (Co and P)

Co and P are elements that form precipitates which are dispersed in the matrix phase of copper.

Here, in the case where a Co content is less than 0.12 mass % and a P content is less than 0.04 mass %, the number of precipitates is insufficient and there is concern that strength may not be sufficiently enhanced. On the contrary, in the case where the Co content is higher than 0.40 mass % and the P content is higher than 0.16 mass %, a large number of elements that do not contribute to the enhancement of strength are present, and there is concern that a reduction in electrical conductivity and the like may be caused.

Therefore, the Co content is set to be in a range of 0.12 mass % or higher to 0.40 mass % or less and the P content is set to be in a range of 0.040 mass % or higher to 0.16 mass % or less.

### (Sn)

Sn is an element having an action of enhancing strength by being solutionized in the matrix phase of copper. In addition, Sn also has an effect of accelerating the precipitation of precipitates primarily containing Co and P and also has an action of enhancing heat resistance and corrosion resistance.

Here, in the case where a Sn content is less than 0.005 mass %, there is concern that the above-described effect may not be reliably achieved. On the contrary, in the case where the Sn content is higher than 0.70 mass %, there is concern that electrical conductivity may not be secured.

Therefore, the Sn content is set to be in a range of 0.005 mass % or higher to 0.70 mass % or less.

### (Ni)

Ni can replace a portion of Co, and Ni is an element having an effect of suppressing the coarsening of grains.

Here, in the case where a Ni content is less than 0.01 mass %, there is concern that the above-described effect may not be reliably achieved. On the contrary, in the case where the Ni content is higher than 0.15 mass %, there is concern that electrical conductivity may not be secured.

Therefore, in the case where Ni is contained, it is preferable that the Ni content be in a range of 0.01 mass % or higher to 0.15 mass % or less.

### (Zn, Mg, Ag, and Zr)

Zn, Mg, Ag, and Zr are elements that produce compounds with sulfur (S) and have an effect of suppressing the sulfur (S) from being solutionized in the matrix phase of copper.

Here, in the case where the contents of the elements Zn, Mg, Ag, and Zr are less than the above-described lower limits, the effect of suppressing the sulfur (S) from being solutionized in the matrix phase of copper cannot be sufficiently achieved. On the contrary, in the case where the contents of the elements Zn, Mg, Ag, and Zr are higher than the above-described upper limits, there is concern that electrical conductivity may not be secured.

Therefore, in the case where the elements Zn, Mg, Ag, and Zr are contained, it is preferable that the contents of the elements be in the above-described ranges.

Here, in the copper alloy wire 1 of this embodiment, the average grain size of precipitates observed through cross-sectional structure observation immediately after performing an intermediate aging heat treatment S03 is equal to or less than 15 nm, the number of precipitates having grain sizes of equal to or less than 5 nm is 10% or higher of the total number of observed precipitates, and cold working (second cold working process S04) is performed after the intermediate aging heat treatment process S03 and a final aging heat treatment (final aging heat treatment process S06) is further performed to manufacture the copper alloy wire 1.

Here, the precipitates were observed as follows. The precipitates were observed by a transmission electron microscope at magnifications of 150,000 and 750,000, and the area of the corresponding precipitates was calculated and an equivalent circle diameter was calculated as a grain size. In addition, the precipitates having grain sizes of 11 nm to 100 nm were measured at a magnification of 150,000, and the precipitates having grain sizes of 1 nm to 10 nm were measured at a magnification of 750,000. During the observation at the magnification of 750,000, the precipitates having grain sizes of less than 1 nm cannot be clearly determined, and thus the total number of observed precipitates becomes the number of precipitates having grain sizes of equal to or greater than 1 nm. In addition, the observation by the transmission electron microscope was performed on a visual field area of about 4×10⁵ nm² in the case of the magnification of 150,000 and the observation was performed on a visual field area of about 2×10⁴ nm² in the case of the magnification of 750,000.

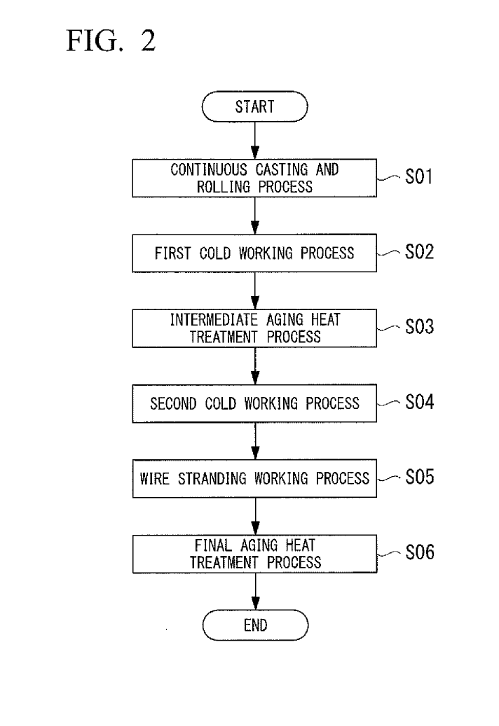

Next, a method for manufacturing the above-described copper alloy wire 1 and a method for manufacturing the electric wire conductor 6 will be described. FIG. 2 illustrates a flowchart of the method for manufacturing the copper alloy wire 1 of the embodiment of the present invention and the method for manufacturing the electric wire conductor 6.

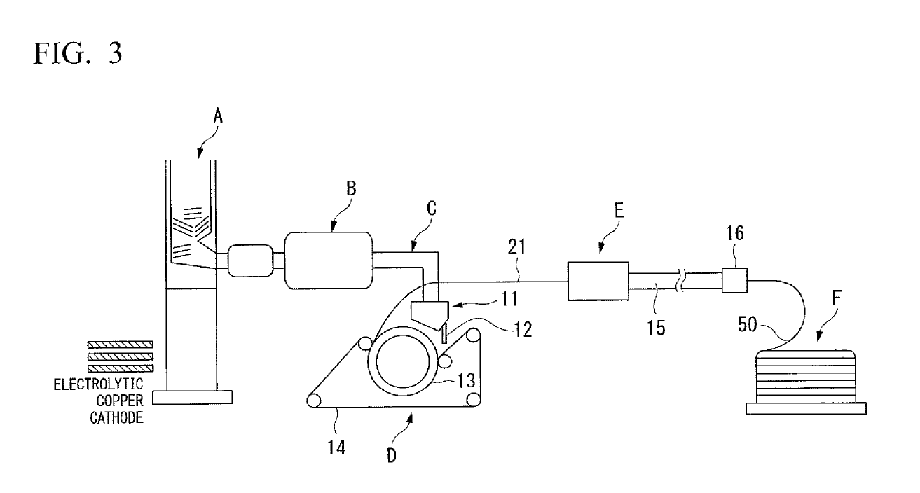

First, a copper wire rod 50 consisting of the above-described copper alloy is continuously produced according to a continuous casting and rolling method (continuous casting and rolling process S01). In the continuous casting and rolling process S01, for example, a continuous casting and rolling facility illustrated in FIG. 3 is used.

The continuous casting and rolling facility illustrated in FIG. 3 includes a melting furnace A, a holding furnace B, a casting launder C, a belt-wheel type continuous casting machine D, a continuous rolling device E, and a coiler F.

In this embodiment, as the melting furnace A, a shaft furnace which includes a cylindrical furnace body is used. A plurality of burners (not illustrated) are arranged in the circumferential direction in the lower part of the furnace body and the burners are arranged in a multi-stage form in the vertical direction. In addition, electrolytic copper cathode which is a raw material is inserted from the upper part of the furnace body and is melted by the combustion of the burners; and thereby, molten copper is continuously produced.

The holding furnace B temporarily stores the molten copper produced in the melting furnace A while being held at a predetermined temperature and the holding furnace B sends a constant amount of the molten copper to the casting launder C.

The casting launder C sends the molten copper sent from the holding furnace B to a tundish 11 disposed above the belt-wheel type continuous casting machine D. The casting launder C is sealed by, for example, an inert gas such as Ar or a reducing gas. In addition, in the casting launder C, a degassing apparatus (not illustrated) for stirring the molten copper using an inert gas to remove oxygen and the like in the molten copper is provided.

The tundish 11 is a storage tank provided to continuously supply the molten copper to the belt-wheel type continuous casting machine D. On the end side of the tundish 11 in the flowing direction of the molten copper, a pouring nozzle 12 is disposed so that the molten copper in the tundish 11 is supplied to the belt-wheel type continuous casting machine D via the pouring nozzle 12.

Here, in this embodiment, an alloy element adding apparatus (not illustrated) is provided in the casting launder C and the tundish 11 to add the above-mentioned elements (Co, P, and Sn) to the molten copper.

The belt-wheel type continuous casting machine D includes: a casting wheel 13 having a groove formed in the outer circumferential surface; and a belt 14 with no ends which revolves and moves so as to come into contact with a part of the outer circumferential surface of the casting wheel 13. In the belt-wheel type continuous casting machine D, the molten copper is poured into a space formed between the groove and the belt 14 with no ends via the pouring nozzle 12, and the molten copper is cooled to solidify; and thereby, a bar-like cast copper 21 is continuously casted.

The continuous rolling device E is connected to the downstream side of the belt-wheel type continuous casting machine D. The continuous rolling device E continuously rolls the cast copper 21 produced from the belt-wheel type continuous casting machine D; and thereby, a copper wire rod 50 having a predetermined outside diameter is produced.

The copper wire rod 50 produced from the continuous rolling device E passes through a washing and cooling device 15 and a flaw detector 16 and is coiled by the coiler F.

Here, the outside diameter of the copper wire rod 50 produced in the continuous casting and rolling facility described above is, for example, equal to or greater than 8 mm and equal to or less than 40 mm, and in this embodiment, the outside diameter is 8 mm.

In addition, in the continuous casting and rolling process S01, the cast copper 21 is held at a relatively high temperature of, for example, 800° C. to 1000° C.; and thereby, a large amount of elements such as Co and P are solutionized in the matrix phase of copper.

Next, as illustrated in FIG. 2, the copper wire rod 50 produced in the continuous casting and rolling process S01 is subjected to cold working (first cold working process S02). In the first cold working process S02, the working is performed in a plurality of stages to form a copper wire material having an outside diameter in a range of equal to or greater than 0.1 mm and equal to or less than 8.0 mm. In this embodiment, the copper wire material has an outside diameter of 0.9 mm.

Next, the copper wire material after the first cold working process S02 is subjected to the intermediate aging heat treatment (intermediate aging heat treatment process S03). In the intermediate aging heat treatment process S03, precipitates consisting of a compound that primarily contains Co and P are precipitated.

Here, in the intermediate aging heat treatment process S03, the intermediate aging heat treatment is performed under the conditions where a heat treatment temperature is 250° C. or higher and 450° C. or less, and a holding time is 0.5 hour or longer and 15 hours or less.

Next, the copper wire material after the intermediate aging heat treatment process S03 is subjected to cold working to produce a copper alloy wire 1 having a predetermined cross-sectional shape (second cold working process S04).

In the second cold working process S04, the working is performed in a plurality of stages to form the copper alloy wire 1 having an outside diameter in a range of equal to or greater than 0.015 mm and equal to or less than 0.2 mm. In this embodiment, the copper alloy wire 1 has an outside diameter of 0.169 mm.

Next, a plurality of copper alloy wires 1 (in this embodiment, seven wires) obtained as described above are stranded together to form an electric wire conductor 6 (wire stranding working process S05). In the wire stranding working process S05, a single copper alloy wire 1 is centered and six copper alloy wires 1 are arranged on the outer circumferential side thereof to be concentrically stranded. In addition, in this embodiment, the stranding pitch in the wire stranding working process S05 is set to be equal to or greater than 4 mm and equal to or less than 24 mm.

In addition, the electric wire conductor 6 obtained in the wire stranding working process S05 is subjected to a batch type heat treatment of holding the electric wire conductor 6 at a temperature of 300° C. or higher and 500° C. or less for 30 minutes or longer and 600 minutes or less (final aging heat treatment process S06).

In the final aging heat treatment process S06, various methods other than the batch type heat treatment may also be used such as a heat treatment where a tubular furnace through which a wire material passes is used, conductive annealing, and the like.

According to the copper alloy wire 1 of the embodiment configured as above and the electric wire conductor 6, the average grain size of precipitates observed through cross-sectional structure observation immediately after performing the intermediate aging heat treatment S03 is equal to or greater than 15 nm, and the number of precipitates having grain sizes of equal to or less than 5 nm is 10% or higher of the total number of observed precipitates. Therefore, a large amount of precipitates having small grain sizes are dispersed. Accordingly, in the subsequent second cold working process S04, dislocation loops are formed from the precipitates having small grain sizes as the start points, and the precipitates having small grain sizes are sheared and divided by the dislocations and thus the precipitates are re-solutionized in the matrix phase of copper.

In addition, when the final aging heat treatment S06 is performed after the second cold working process S04, Co and P that are re-solutionized are re-precipitated on the dislocation loops as the precipitation sites. Accordingly, a large amount of the precipitates having small grain sizes are dispersed. Therefore, electrical conductivity is enhanced and strength is also enhanced by precipitation strengthening. In addition, due to this heat treatment, the dislocations are released and thus elongation is recovered. Therefore, the copper alloy wire 1 and the electric wire conductor 6 which are excellent in strength and elongation can be manufactured.

Specifically, the copper alloy wire 1 of this embodiment has a tensile strength of 450 MPa or higher and an elongation of 5% or higher, and thus it is possible to achieve a reduction in the diameter of the wire harness.

In this embodiment, since the composition of the copper alloy wire 1 contains: 0.12 mass % or higher to 0.40 mass % or less of Co; 0.040 mass % or higher to 0.16 mass % or less of P; and 0.005 mass % or higher to 0.70 mass % or less of Sn, with the remainder being Cu and unavoidable impurities, precipitates consisting of compounds primarily containing Co and P are dispersed in the matrix phase of copper. Accordingly, it is possible to achieve the enhancement of strength and electrical conductivity. In addition, since Sn is contained at a content in a range of 0.005 mass % or higher to 0.70 mass % or less, the strength can further be enhanced by solid solution strengthening. Accordingly, strength and a repeated bending characteristic can be enhanced. In addition, heat resistance and corrosion resistance are also enhanced.

Furthermore, in this embodiment, since 0.01 mass % or higher to 0.15 mass % or less of Ni is further contained, the coarsening of grains can be suppressed; and thereby, strength can be further enhanced.

In addition, in this embodiment, since one or more selected from 0.002 mass % or higher to 0.5 mass % or less of Zn, 0.002 mass % or higher to 0.25 mass % or less of Mg, 0.002 mass % or higher to 0.25 mass % or less of Ag, and 0.001 mass % or higher to 0.1 mass % or less of Zr are contained, the elements such as Zn, Mg, Ag, and Zr form compounds with sulfur (S); and thereby, it is possible to suppress the sulfur (S) from being solutionized in the matrix phase of copper. As a result, it is possible to suppress the deterioration of mechanical properties such as the strength and the like of the copper alloy wire 1.

In addition, in this embodiment, since the copper wire rod 50 is produced in the continuous casting and rolling process 501, the copper wire rod 50 can be efficiently produced. In addition, since the copper wire rod 50 is held for a predetermined time in a high temperature state of; for example, 800 to 1000° C., the elements such as Co, P, and the like are solutionized in the matrix phase of copper. Accordingly, it is not necessary to conduct an additional solutionizing treatment.

While the embodiment of the present invention has been described, the present invention is not limited thereto, and modifications can be appropriately made without departing from the technical features of the present invention.

For example, in this embodiment, the copper alloy wire included in the electric wire conductor and the covered electric wire used as the wire harness for a vehicle is described. However, the embodiment is not limited thereto, and a copper alloy wire included in an electric wire conductor and a covered electric wire used as the wire harness for a device such as a copier may also be applied.

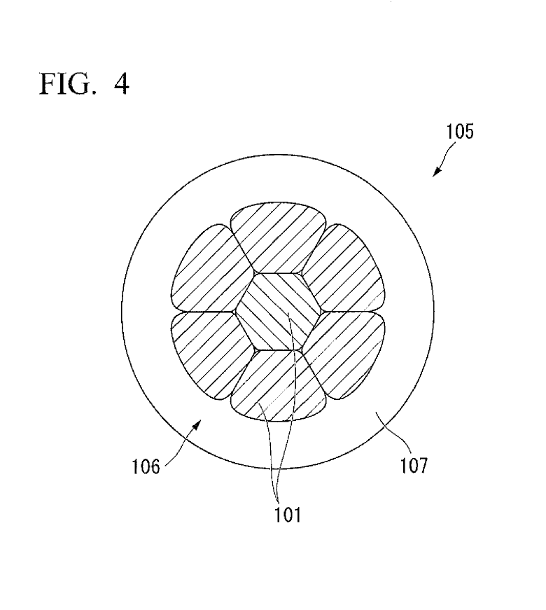

Furthermore, in this embodiment, the copper alloy wire included in the electric wire conductor and the covered electric wire as illustrated in FIG. 1 is described. However, the embodiment is not limited thereto, and as illustrated in FIG. 4, the copper alloy wire may be applied to an electric wire conductor 106 and a covered electric wire 105 made by subjecting stranded wires to compression working. In this case, it is preferable that the final aging heat treatment be performed after the compression working.

In addition, the final aging heat treatment process is performed after the wire stranding working process in the description. However, the embodiment is not limited thereto, and the final aging heat treatment may be performed on a single wire and thereafter the wire stranding working process may be performed.

Furthermore, in this embodiment, the copper wire rod is manufactured by the continuous casting and rolling process in the description. However, the embodiment is not limited thereto, and a columnar ingot (billet) may be produced and the ingot may be extruded and cold-worked to produce the copper wire rod. In the case where the copper wire rod is produced by the extrusion method, it is necessary to perform an additional solutionizing treatment. Moreover, even in the case where the copper wire rod is manufactured by the continuous casting and rolling process, the copper wire rod may also be subjected to a solutionizing treatment.

In addition, in this embodiment, the continuous casting and rolling process is performed by using the belt-wheel type continuous casting machine illustrated in FIG. 3 in the description. However, the embodiment is not limited thereto, and another continuous casting method may also be employed.

### EXAMPLES

Hereinafter, the results of a confirmation test performed to check the effectiveness of the present invention will be described.

### INVENTION EXAMPLES AND COMPARATIVE EXAMPLES

By using a continuous casting and rolling facility provided with a belt-wheel type continuous casting machine, a copper wire rod (a diameter of 8 mm) consisting of a copper alloy having the composition shown in Table 1 was produced. First cold working was performed on the copper wire rod to have a diameter of 0.9 mm, and then an intermediate aging heat treatment was performed on the resultant under the conditions shown in Table 1. Thereafter, second cold working was performed thereon to have a diameter of 0.165 mm, and a final aging heat treatment was performed thereon under the conditions shown in Table 1.

(Observation of Precipitates after Intermediate Aging Heat Treatment)

In Invention Examples, the precipitates were observed by using copper wire materials after the intermediate aging heat treatment. The observation of the precipitates was performed by using a transmission electron image of a transmission electron microscope (model name: TEM: H-800, HF-2000, and HF-2200 manufactured by Hitachi, Ltd., and JEM-2010F manufactured by JEOL Ltd.), and an equivalent grain size was calculated from the area of each precipitate. In addition, the observation was performed at magnifications of 150,000 and 750,000 on visual field areas of about 4×10⁵ nm² and 2×10⁴ nm², respectively. In addition, the average grain size of the precipitates and the ratio of precipitates having grain sizes of equal to or greater than 5 nm to the observed precipitates were calculated. The results are shown in Table 2.

### (Tensile Strength and Elongation)

A tensile test was performed by using AG-5kNX manufactured by Shimadzu Corporation in accordance with JIS Z 2241 to measure tensile strength and elongation. The results are shown in Table 2.

TABLE 1

| | | | | | | | | | Intermediate aging | | Final aging heat | |
|---|---|---|---|---|---|---|---|---|---|---|---|---|
| | | | | | | | | | heat treatment | | treatment | |
| | Composition (wt %) | | | | | | | | Temperature | Time | Temperature | Time |
| | Co | P | Sn | Ni | Zn | Mg | Ag | Zr | (° C.) | (min) | (° C.) | (min) |
| Invention Example 1 | 0.14 | 0.08 | 0.04 | — | — | — | — | — | 450 | 60 | 400 | 60 |
| Invention Example 2 | 0.24 | 0.077 | 0.03 | — | — | — | — | — | 400 | 180 | 380 | 180 |
| Invention Example 3 | 0.38 | 0.084 | 0.04 | — | — | — | — | — | 425 | 210 | 380 | 60 |
| Invention Example 4 | 0.24 | 0.06 | 0.04 | — | — | — | — | — | 375 | 60 | 375 | 240 |
| Invention Example 5 | 0.25 | 0.14 | 0.03 | — | — | — | — | — | 375 | 60 | 410 | 60 |
| Invention Example 6 | 0.26 | 0.088 | 0.006 | — | — | — | — | — | 400 | 60 | 380 | 180 |
| Invention Example 7 | 0.25 | 0.081 | 0.68 | — | — | — | — | — | 375 | 120 | 390 | 60 |
| Invention Example 8 | 0.23 | 0.091 | 0.04 | 0.02 | — | — | — | — | 350 | 240 | 390 | 60 |
| Invention Example 9 | 0.24 | 0.077 | 0.03 | 0.03 | — | — | — | — | 275 | 60 | 430 | 120 |
| Invention Example 10 | 0.25 | 0.079 | 0.04 | 0.12 | 0.012 | — | — | — | 275 | 600 | 400 | 60 |
| Invention Example 11 | 0.23 | 0.08 | 0.04 | 0.03 | 0.006 | — | — | — | 325 | 60 | 375 | 300 |
| Invention Example 12 | 0.31 | 0.097 | 0.05 | 0.04 | — | 0.05 | — | — | 300 | 120 | 440 | 60 |
| Invention Example 13 | 0.24 | 0.075 | 0.1 | 0.04 | — | — | 0.03 | 0.025 | 325 | 60 | 375 | 540 |
| Invention Example 14 | 0.09 | 0.077 | 0.05 | — | — | — | — | — | 325 | 60 | 430 | 60 |
| Invention Example 15 | 0.44 | 0.075 | 0.04 | — | — | — | — | — | 375 | 60 | 420 | 60 |
| Invention Example 16 | 0.25 | 0.03 | 0.04 | — | — | — | — | — | 325 | 120 | 420 | 60 |
| Invention Example 17 | 0.24 | 0.19 | 0.03 | — | — | — | — | — | 350 | 240 | 410 | 120 |
| Invention Example 18 | 0.24 | 0.077 | 0.004 | — | — | — | — | — | 325 | 240 | 440 | 60 |
| Invention Example 19 | 0.28 | 0.081 | 0.72 | — | — | — | — | — | 400 | 60 | 410 | 120 |
| Comparative Example 1 | 0.25 | 0.078 | 0.04 | 0.04 | 0.015 | — | — | — | 500 | 60 | 400 | 60 |
| Comparative Example 2 | 0.30 | 0.094 | 0.05 | 0.04 | 0.015 | — | — | — | 580 | 30 | 410 | 60 |
| Comparative Example 3 | 0.21 | 0.066 | 0.1 | 0.05 | 0.014 | — | — | — | 580 | 60 | 410 | 60 |

TABLE 2

| | Observation of | | | |
|---|---|---|---|---|
| | precipitates after | | | |
| | intermediate aging | | | |
| | heat treatment process | | | |
| | Average | Ratio of | Tensile | |
| | grain | 5 nm or | strength | Elongation |
| | size (nm) | less (%) | (MPa) | (%) |
| Invention Example 1 | 10.3 | 19 | 510 | 5.9 |
| Invention Example 2 | 7.2 | 33 | 510 | 7.8 |
| Invention Example 3 | 9.1 | 24 | 530 | 7 |
| Invention Example 4 | 8.3 | 33 | 550 | 5.3 |
| Invention Example 5 | 7.6 | 34 | 500 | 8.5 |
| Invention Example 6 | 9.1 | 29 | 510 | 7.4 |
| Invention Example 7 | 8.9 | 41 | 550 | 5.9 |
| Invention Example 8 | 8.8 | 35 | 530 | 7.3 |
| Invention Example 9 | 7.8 | 29 | 540 | 6.5 |
| Invention Example 10 | 8.5 | 29 | 510 | 8.6 |
| Invention Example 11 | 9.3 | 28 | 510 | 7.8 |
| Invention Example 12 | 8.4 | 32 | 530 | 6.8 |
| Invention Example 13 | 9.1 | 29 | 520 | 6.4 |
| Invention Example 14 | 9.9 | 33 | 460 | 4.1 |
| Invention Example 15 | 10.7 | 31 | 480 | 4.0 |
| Invention Example 16 | 8.5 | 30 | 450 | 4.3 |
| Invention Example 17 | 8.4 | 25 | 480 | 3.9 |
| Invention Example 18 | 9.1 | 31 | 470 | 4.5 |
| Invention Example 19 | 8.8 | 24 | 460 | 4.3 |
| Comparative Example 1 | 32 | 3 | 430 | 2.8 |
| Comparative Example 2 | 48 | 1 | 430 | 2.5 |
| Comparative Example 3 | 40 | 3 | 440 | 2.1 |

In Comparative Examples 1 to 3 in which the average grain sizes of the precipitates were equal to or greater than 15 nm and the ratios of the precipitates having sizes of 5 nm or less were less than 10%, both tensile strength and elongation could not be enhanced.

On the contrary, in Invention Examples 1 to 19 in which the average grain sizes of the precipitates were equal to or less than 15 nm and the ratios of the precipitates of 5 nm or less were equal to or higher than 10%, both tensile strength and elongation could be enhanced.

### INDUSTRIAL APPLICABILITY

The present invention relates to a copper alloy wire which is excellent in strength and elongation and thus can achieve a reduction in the diameter of a wire harness, and a copper alloy wire manufacturing method.

### EXPLANATION OF NUMERALS

1 COPPER ALLOY WIRE

5 INSULATION ELECTRIC WIRE

6 ELECTRIC WIRE CONDUCTOR

1. A copper alloy wire consisting of
a precipitation strengthening type copper alloy containing Co, P, and Sn, wherein
an average grain size of precipitates observed through cross-sectional structure observation immediately after performing an intermediate aging heat treatment is equal to or less than 15 nm, and a number of precipitates having grain sizes of equal to or less than 5 nm is 10% or higher of a total number of observed precipitates, and
the copper alloy wire is subjected to cold working and a final aging heat treatment after the intermediate aging heat treatment.

2. The copper alloy wire according to claim 1, wherein a composition of the precipitation strengthening type copper alloy comprises:
0.12 mass % or higher to 0.40 mass % or less of Co;
0.040 mass % or higher to 0.16 mass % or less of P; and
0.005 mass % or higher to 0.70 mass % or less of Sn,
with the remainder being Cu and unavoidable impurities.

3. The copper alloy wire according to claim 2, wherein the precipitation strengthening type copper alloy further comprises:
0.01 mass % or higher to 0.15 mass % or less of Ni.

4. The copper alloy wire according to claim 2, wherein the precipitation strengthening type copper alloy further comprises one or more selected from 0.002 mass % or higher to 0.5 mass % or less of Zn, 0.002 mass % or higher to 0.25 mass % or less of Mg, 0.002 mass % or higher to 0.25 mass % or less of Ag, and 0.001 mass % or higher to 0.1 mass % or less of Zr.

5. A method for manufacturing a copper alloy wire consisting of a precipitation strengthening type copper alloy containing Co, P, and Sn, the method comprising:
an intermediate aging heat treatment process;
a cold working process performed after the intermediate aging heat treatment process; and
a final aging heat treatment process performed after the cold working process,
wherein an average grain size of precipitates observed through cross-sectional structure observation immediately after performing the intermediate aging heat treatment process is made to be equal to or less than 15 nm and a number of precipitates having grain sizes of equal to or less than 5 nm is made to be 10% or higher of a total number of observed precipitates.

6. The copper alloy wire according to claim 3, wherein the precipitation strengthening type copper alloy further comprises one or more selected from 0.002 mass % or higher to 0.5 mass % or less of Zn, 0.002 mass % or higher to 0.25 mass % or less of Mg, 0.002 mass % or higher to 0.25 mass % or less of Ag, and 0.001 mass % or higher to 0.1 mass % or less of Zr.
